(19) United States
(12) Patent Application Publication
(10) Pub. No.: US 2026/0318188 A1
(43) Pub. Date: Oct. 15, 2026

(54) SYSTEM AND METHOD FOR NON-INVASIVE ASSESSMENT OF A STRUCTURE

(71) Applicant: Saudi Arabian Oil Company, DHAHRAN (SA)

(72) Inventors: Ali Musa Alhussain, Khobar (SA); Mohammed Ali AlAmeer, Khobar (SA)

(73) Assignee: Saudi Arabian Oil Company, DHAHRAN (SA)

(21) Appl. No.: 19/178,369

(22) Filed: Apr. 14, 2025

(51) Int. Cl. E21B 47/113; G01M 3/38

(52) U.S. Cl. CPC E21B 47/114; G01M 3/38

(57) ABSTRACT

A system and method perform non-invasive assessment of a valve of a wellhead. The system includes a radiation source, a sensor signal receiver, a sensor structure surrounding the structure under test, and an analysis system. The radiation source includes electromagnetic radiation including laser light. The sensor structure generates sensor signals corresponding to changes in the electromagnetic radiation due to leaks or anomalies of the valve. The sensor signal receiver receives the sensor signals, generates a signature signal corresponding to the sensor signals, and transmits the signature signal to the analysis system. The analysis system compares the signature signal to patterns of anomalies stored in a database. If there is a match of the signature signal to an anomaly, the system generates and outputs a notification of an anomaly of the valve. The method implements the system.

### FIELD OF THE DISCLOSURE

The present disclosure relates generally to assessing structures for leaks, and, more particularly, to a system and method for non-invasive assessment of a structure.

### BACKGROUND OF THE DISCLOSURE

To assess integrity of a valve of a wellhead in the field of petroleum and natural gas extraction, pressure gauges are used to detect leaks. However, pressure gauges are an invasive detection technique which requires establishment of a direct physical connection to the valve, potentially interrupting the function of the valve.

### SUMMARY OF THE DISCLOSURE

According to an implementation consistent with the present disclosure, a system and method perform non-invasive assessment of a structure.

In an implementation, an assessment system is configured to assess a given structure, with the assessment system comprising a radiation source, a sensor structure, a sensor signal receiver, and an analysis system. The radiation source is configured to emit a predetermined electromagnetic radiation towards the given structure. The sensor structure is configured to detected electromagnetic radiation corresponding to changes in the predetermined electromagnetic radiation due to the given structure. A sensor signal receiver is configured to receive a detection signal corresponding to the detected electromagnetic radiation, to generate a signature signal corresponding to the detected electromagnetic radiation, and to transmit the signature signal. The analysis system includes a memory, a hardware-based processor, and an output device. The memory is configured to store a database of predetermined patterns each corresponding to a respective anomaly in the given structure. The hardware-based processor is responsive to receiving the signature signal to compare the signature signal to the predetermined patterns, to determine any match of the signature signal to a first predetermined pattern, and to generate a notification of an anomaly of the given structure in the case of a match of the signature signal to at least one of the predetermined patterns. The output device is configured to output the notification to a user.

The radiation source can be a laser configured to emit a laser beam as the predetermined electromagnetic radiation towards the given structure. The sensor structure can further comprise a curved structure surrounding at least a portion of the given structure. The sensor structure can further comprise a reflective surface configured to detect the predetermined electromagnetic radiation incident in the surroundings of the given structure, and to reflect the detected electromagnetic radiation as the detection signal to the sensor signal receiver. The sensor structure can further comprise at least one sensor embedded in the curved structure to detect the predetermined electromagnetic radiation incident in the surroundings of the given structure, and to generate the detection signal corresponding to the detected electronic radiation. At least one electrical wire can be configured to transmit the detection signal to the sensor signal receiver. The curved structure can have a shape configured to surround at least a portion of the given structure, wherein the shape can be selected from the group consisting of a complete ring, a complete annulus, a hemispheres, a portion of a sphere, a ring with a gap, or an annulus with a gap.

The sensor structure can further comprise at least one fastener configured to selectively fix and secure the curved structure in a selected shape and size surrounding the given structure. The assessment system can further comprise a communication channel transmit the signature signal from the sensor signal receiver to the analysis system. The communication channel can be a wired connection. Alternatively, the communication channel can be a wireless connection.

In another implementation, a method to assess a given structure comprises emitting a predetermined electromagnetic radiation from a radiation source towards the given structure, detecting electromagnetic radiation corresponding to changes in the predetermined electromagnetic radiation due to the given structure by a sensor structure, receiving a detection signal corresponding to the detected electromagnetic radiation, generating a signature signal corresponding to the detected electromagnetic radiation, transmitting the signature signal to an analysis system, receiving the signature signal at the analysis system, retrieving at least one predetermined pattern from a database with the at least one predetermined pattern corresponds to an anomaly of the given structure, comparing the signature signal to the at least one predetermined pattern, and determining any match of the signature signal to a first predetermined pattern. Responsive to a match of the signature signal to a first predetermined pattern, the method generates and outputs a notification of an anomaly of the given structure corresponding to the anomaly corresponding to the first predetermined pattern, and outputs, through a user interface, the notification of the anomaly of the given structure to a user.

The radiation source can be a laser emitting a laser beam as the predetermined radiation towards the given structure. Prior to emitting the predetermined electromagnetic radiation, the method can include surrounding at least a portion of the given structure with a portion of a curved structure of the sensor structure. The portion of the curved structure can have a shape configured to surround at least the portion of the given structure, wherein the shape is selected from the group consisting of a complete ring, a complete annulus, a hemispheres, a portion of a sphere, a ring with a gap, or an annulus with a gap. Prior to detecting the electromagnetic radiation, the method can provide a reflective surface on the curved structure, wherein detecting the predetermined electromagnetic radiation incident in the surroundings of the given structure includes reflecting the detected electromagnetic radiation as a detection signal to a sensor signal receiver.

Any combinations of the various embodiments, implementations, and examples disclosed herein can be used in a further implementation, consistent with the disclosure. These and other aspects and features can be appreciated from the following description of certain implementations presented herein in accordance with the disclosure and the accompanying drawings and claims.

### BRIEF DESCRIPTION OF THE DRAWINGS

FIG. 1 is a front view of an assessment system according to an implementation.

FIG. 2 is an enlarged portion of the front view of the assessment system of FIG. 1.

FIG. 3 is a side view of the enlarged portion in FIG. 2.

FIG. 4 is an elevational view along the lines 4-4 in FIG. 3.

FIG. 5 is a side view of an alternative implementation of the enlarged portion in FIG. 2.

FIG. 6 is an elevational view along the lines 6-6 in FIG. 5.

FIG. 7 is a front view of an alternative implementation of a sensor structure.

FIG. 8 is a schematic of a computing device used in the implementation.

FIG. 9 is a flowchart of operation of a method implementing the assessment system of FIG. 1.

FIG. 10 is a flowchart of operation of a method of analyzing a signature signal.

FIG. 11 is a flowchart of adjusting the sensor structure of FIG. 7.

It is noted that the drawings are illustrative and are not necessarily to scale.

### DETAILED DESCRIPTION OF CERTAIN EMBODIMENTS OF THE DISCLOSURE

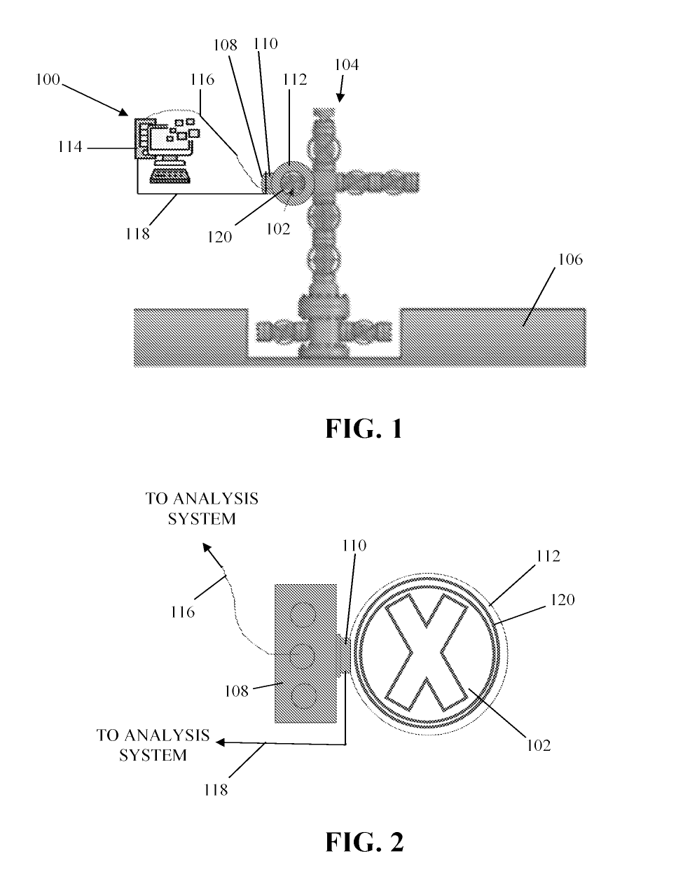

Example embodiments and implementations consistent with the teachings included in the present disclosure are directed to an assessment system 100 and method 900 for non-invasive assessment of a given structure as shown in FIGS. 1-11. In an implementation consistent with the invention, the assessment system 100 performs non-invasive assessment of a valve 102 or other structures of a wellhead 104 disposed in a geographic region 106 associated with a petroleum or natural gas reservoir.

Referring to FIG. 1, in one implementation, the assessment system 100 includes a radiation source 108, a sensor signal receiver 110, a sensor structure 112, and an analysis system 114. The radiation source 108 is any known source of any known electromagnetic radiation. For example, the radiation source 108 is a laser configured to generate and emit a laser beam. In another example, the radiation source 108 is an ultraviolet (UV) radiation source configured to generate and emit UV rays.

At least one portion of the sensor structure 112 is curved and positioned within a detection distance of the valve 102 and configured to detect sensor signals emitted by radiation within the detection distance. In one implementation, the detection distance is 1 mm., such that at least one portion of the sensor structure 112 is disposed within 1 mm. of the value 102. For example, the at least one portion of the sensor structure 112 is adjacent to the value 102. In another implementation, the detection distance is a predetermined distance associated with the at least one portion of the sensor structure 112, such that radiation within the predetermined distance according to a known specification of the sensor structure 112.

The analysis system 114 is operatively connected to the radiation source 108 by a communication channel 116, so that the analysis system 114 transmits control signals to the radiation source 108. The analysis system 114 is also operatively connected to the sensor signal receiver 110 by a communication channel 118, so that the analysis system 114 receives signature signals from the sensor signal receiver 110, as described below. In one implementation, at least one of the communication channels 116, 118 is a wired electrical connection physically connecting a communication interface of the analysis system 114 to the radiation source 108 or the sensor signal receiver 110, respectively. The communication interface operates a predetermined wired communication protocol to communicate, transmit, and receive signals to and from the radiation source 108 and the sensor signal receiver 110. The predetermined wired communication protocol is any known type of wired communication protocol.

In one implementation, the analysis system 114 is operatively connected to the equipment 108, 110 and a data source through a network. For example, the network is the Internet. In another example, the network is an internal network or intranet of an organization. In a further example, the network is a heterogeneous or hybrid network including the Internet and the intranet.

In another implementation, at least one of the communication channels 116, 118 is a wireless connection wirelessly connecting the communication interface of the analysis system 114 to a signal transmitter of the radiation source 108 or the sensor signal receiver 110, respectively. The communication interface operates a predetermined wireless communication protocol to communicate, transmit, and receive signals to and from the radiation source 108 and the sensor signal receiver 110. The predetermined wireless communication protocol is any known type of wired communication protocol.

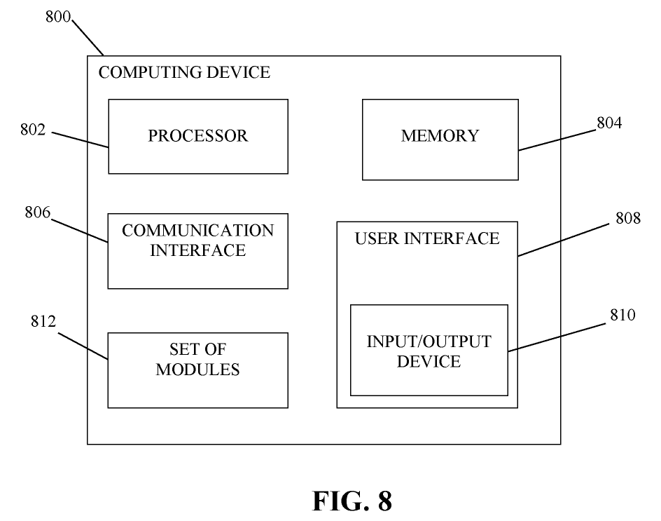

In an implementation consistent with the invention, the analysis system 114 includes a computing device 800 having a hardware-based processor 802, a memory 804 configured to store instructions and configured to provide the instructions to the hardware-based processor 802, a communication interface 806, a user interface (UI) 808 including an input/output (I/O) device 810, and a set 812 of modules configured to implement the instructions provided to the hardware-based processor 802, as shown in FIG. 8.

Referring to FIG. 8, in one implementation, the user interface 808 includes an input device, such a keyboard, a keypad, a mouse, or a touchscreen. In another implementation, the user interface 808 includes an output device such as a display, a monitor, a hardcopy printer, or a touchscreen. In a further implementation, the user interface 808 includes the input/output device 810. The processor 802, the memory 804, the communication interface 806, and the user interface 808 are operatively connected to each other via any known connections, such as a system bus, a network, etc. Any component, combination of components, and modules of the analysis system 114 in FIG. 1 can be implemented by a respective computing device 800 shown in FIG. 8. In one implementation, a module of the set 812 of modules includes software, such as an application, a procedure, a subroutine, a software-based object, or any known type of software. In another implementation, a module of the set 812 of modules includes hardware, such as a hardware-based computing device, a hardware-based processor, a microprocessor, or any known type of hardware configured to perform functions. In a further implementation, a module of the set 812 of modules includes both software and hardware.

It is to be understood that the computing device 800 can include different components. Alternatively, the computing device 800 can include additional components. In another alternative implementation, some or all of the functions of a given component can instead be carried out by one or more different components. The computing device 800 can be implemented by a virtual computing device. Alternatively, the computing device 800 can be implemented by one or more computing resources in a cloud computing environment. Additionally, the computing device 800 can be implemented by a plurality of any known computing devices.

The processor 802 can be a hardware-based processor implementing a system, a sub-system, or a module. The processor 802 can include one or more general-purpose processors. Alternatively, the processor 802 can include one or more special-purpose processors. The processor 802 can be integrated in whole or in part with the memory 804, the communication interface 806, and the user interface 808. In another alternative implementation, the processor 802 can be implemented by any known hardware-based processing device such as a controller, an integrated circuit, a microchip, a central processing unit (CPU), a microprocessor, a system on a chip (SoC), a field-programmable gate array (FPGA), or an application-specific integrated circuit (ASIC). In addition, the processor 802 can include a plurality of processing elements configured to perform parallel processing. In a further alternative implementation, the processor 802 can include a plurality of nodes or artificial neurons configured as an artificial neural network. The processor 802 can be configured to implement any known machine learning (ML) based devices, any known artificial intelligence (AI) based devices, and any known artificial neural networks, including a convolutional neural network (CNN).

Referring to FIGS. 1 and 8, the memory 804 is configured to store, maintain, and access at least one database, such as a signature pattern database, as described in greater detail below. The memory 804 can be implemented as a non-transitory computer-readable storage medium such as a hard drive, a solid-state drive, an erasable programmable read-only memory (EPROM), a universal serial bus (USB) storage device, a floppy disk, a compact disc read-only memory (CD-ROM) disk, a digital versatile disc (DVD), cloud-based storage, or any known non-volatile storage.

The instructions of the processor 802 include code which can be stored in a memory internal to the processor 802. The code can be instructions implemented in hardware. Alternatively, the code can be instructions implemented in software. The instructions can be machine-language instructions executable by the processor 802 to cause the computing device 800 to perform the functions of the computing device 800 described herein. Alternatively, the instructions can include script instructions executable by a script interpreter configured to cause the processor 802 and computing device 800 to execute the instructions specified in the script instructions. In another alternative implementation, the instructions are executable by the processor 802 to cause the computing device 800 to execute an artificial neural network. The processor 802 can be implemented using hardware or software, such as the code. The processor 802 can implement a system, a sub-system, or a module, as described herein.

The memory 804 can store data in any known format, such as databases, data structures, data lakes, or network parameters of a neural network. The data can be stored in a table, a flat file, data in a filesystem, a heap file, a B+ tree, a hash table, or a hash bucket. The memory 804 can be implemented by any known memory, including random access memory (RAM), cache memory, register memory, or any other known memory device configured to store instructions or data for rapid access by the processor 802, including storage of instructions during execution.

The communication interface 806 can be any known device configured to perform the communication interface functions of the computing device 800 described herein. The communication interface 806 can implement wired communication between the computing device 800 and another entity. Alternatively, the communication interface 806 can implement wireless communication between the computing device 800 and another entity. The communication interface 806 can be implemented by an Ethernet, Wi-Fi, Bluetooth, or USB interface. The communication interface 806 can transmit and receive data over a network and to other devices using any known communication link or communication protocol.

The user interface 808 can be any known device configured to perform user input and output functions. The user interface 808 can be configured to receive an input from a user. Alternatively, the user interface 808 can be configured to output information to the user. The user interface 808 can be a computer monitor, a television, a loudspeaker, a computer speaker, or any other known device operatively connected to the computing device 800 and configured to output information to the user. A user input can be received through the user interface 808 implementing a keyboard, a mouse, or any other known device operatively connected to the computing device 800 to input information from the user. Alternatively, the user interface 808 can be implemented by any known touchscreen. The computing device 800 can include a server, a personal computer, a laptop, a smartphone, or a tablet. Accordingly, in one implementation, the analysis system 114, including the computing device 800, has a housing configured and dimensioned to be portable. For example, the assessment system 100 is configured such that the analysis system 114 and the other equipment 108, 110, 112, 116, and 118 are transportable by a technician or engineer to be taken from wellhead 104 to another wellhead.

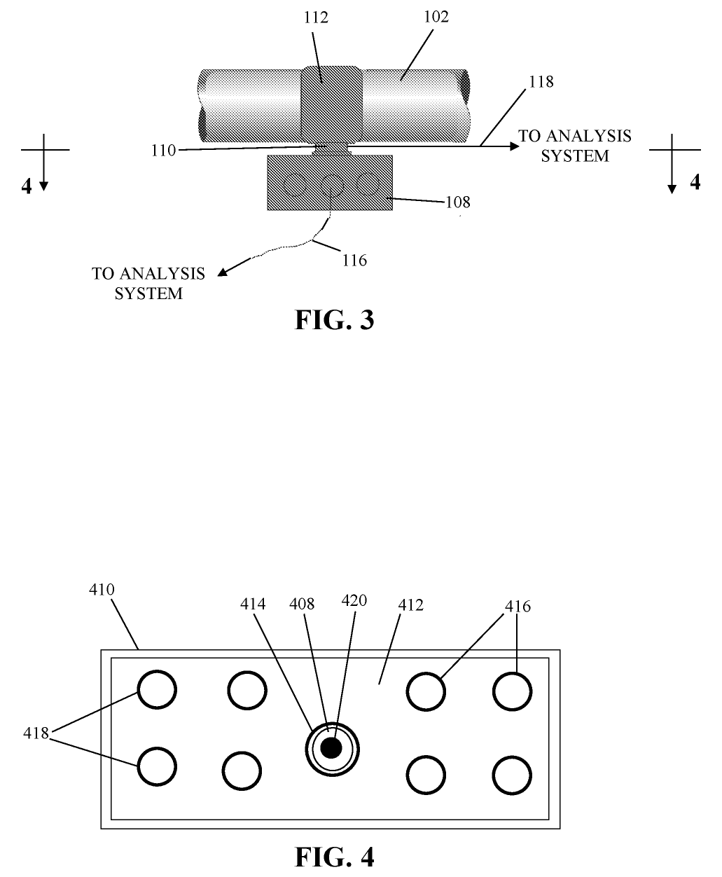

In one implementation of the assessment system 100 of FIG. 1, FIGS. 2-3 illustrate enlarged portions of the assessment system 100 of FIG. 1, with the sensor structure 112 includes a reflective surface 120. For example, the reflective surface 120 includes a mirror or any known material or structure configured to reflect electromagnetic radiation.

In the implementation shown in FIGS. 2-4, the sensor structure 112 including the reflective surface 120 surrounds at least a portion of the valve 102. For example, the sensor structure 112 completely surrounds the valve 102. Referring to FIG. 4, the sensor signal receiver 410 includes a surface 412 with an aperture 414 and at least one exposed sensor 416, 418 distributed along the surface 412. An emitting portion 408 of the radiation source 108 of FIG. 1 is exposed through the aperture 414, such that an emitted beam or ray 420 of radiation is transmitted to be incident on the valve 102 and to also pass through the surroundings of the valve 102.

As described below, the radiation passes around the valve 102 and is reflected by the reflective surface 120 back to the sensors 416, 418 of the sensor signal receiver 410. The reflected radiation includes at least one sensor signal which represents changes in the radiation due to leaks from the valve 102. Alternatively, the sensor signal represents changes in the radiation due to anomalies associated with the valve 102. For example, the anomalies occur since, once the radiation from the radiation source 108 reaches the valve 102, a reflection of the beam or ray 420 back to the radiation source 108 with minimal scattering shows how the valve 102 absorbs the beam or ray 420. In one implementation, the beam or ray 420 of radiation from the radiation source 108 is a high-power beam such as a high-power laser beam. Inconsistent beam characteristics with a high level of absorption reflectance are indicative of a passing, weakened, or aging valve such as the value 102, or a weakness in the wellhead 104.

In response to receiving the reflected radiation, the sensor signal receiver 410 generates a signature signal corresponding to the received sensor signals, which are transmitted via the communication channels 116, 118 to the analysis system 114.

The analysis system 114 uses predetermined methods to analyze the signature signal, and to generate and output a notification of the results of the analysis. As described in greater detail below, the analysis system 114 analyzes the signature signal by retrieving at least one predetermined signature pattern from a signature pattern database stored in the memory 804, and comparing the signature signal to the at least one predetermined signature pattern. The at least one predetermined signature pattern represents signals corresponding to known leaks, anomalies, or other irregularities associated with the valve 102. The analysis system 114 determines whether the signature signal matches any of the at least one predetermined signature pattern in the signature pattern database to within a predetermined tolerance. In one implementation, the predetermined tolerance is 1 %, indicating that about 99 % of the signature signal matches at least one predetermined signature pattern. In another implementation, the analysis system 114 performs a correlation of the signature signal and each of the at least one predetermined signature pattern, and a correlation of greater than 99 % indicates that the signature signal matches at least one predetermined signature pattern.

If no match of the signature signal matches at least one predetermined signature pattern, then the analysis system 114 determines that no anomalies are present in the operation of the valve 102. However, if a match of the signature signal with at least one predetermined signature pattern is determined, then the analysis system 114 determines that an anomaly is detected in the operation of the valve 102, with the anomaly corresponding to the matched at least one predetermined signature. The analysis system 114 then generates and outputs a notification of the presence or absence of an anomaly in the operation of the valve 102. In one implementation, the notification is output by the user interface 808, such as a displayed message to a user on a display implementing the input/output device 810. In another implementation, the notification is output by the user interface 808 as a physical printout provided to a user from a printer implementing the input/output device 810. In another implementation, the analysis system 114 generates and outputs a report including the notification transmitted through the communication interface 806 to external systems monitoring the wellhead 104 and the valves 102 of the wellhead. In an implementation, the report includes information about the type and severity of the anomaly or leak of the valve.

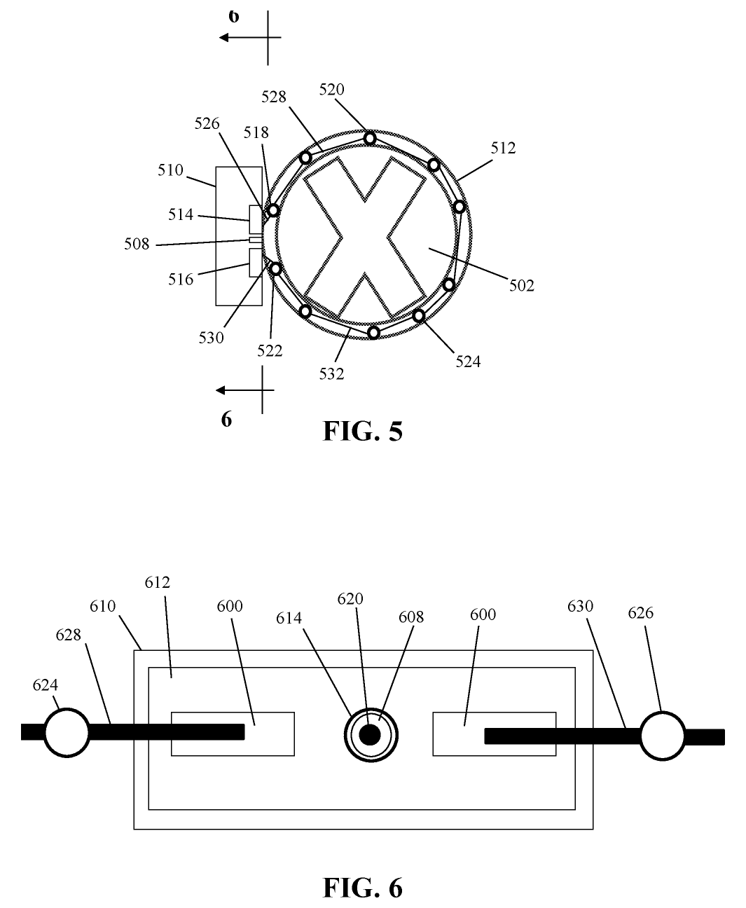

In another implementation as shown in FIGS. 5-6, a sensor signal receiver 510 is associated with a radiation source 508, which emits radiation to a sensor structure 512 surrounding at least a portion of the valve 502. The sensor signal receiver 510 includes at least one port 514, 516 operatively connected to at least one sensor 518, 520, 522, 524 by electrical wires 526, 528, 530, 532, respectively. The at least one sensor 518, 520, 522, 524 and the electrical wires 526, 528, 530, 532 are embedded in the sensor structure 512, such that the at least one sensor 518, 520, 522, 524 is distributed about the valve 502.

Referring to FIG. 6, the signal receiver 610 includes a surface 612 with an aperture 614 and at least one port 614, 616. An emitting portion 608 of the radiation source 108 of FIG. 1 is exposed through the aperture 618, such that an emitted beam or ray 620 of radiation is transmitted to be incident on the valve 102 and to also pass through the surroundings of the valve 102. As described below, the radiation passes around the valve 102 and is detected by the at least one sensor 624, 626 embedded in the sensor structure 512 shown in FIG. 5.

The at least one sensor 624, 626 generates a sensor signal which represents changes in the radiation due to leaks from the valve 102. Alternatively, the sensor signal represents changes in the radiation due to anomalies associated with the valve 102. For example, the anomalies occur since, once the radiation from the radiation source 108 reaches the valve 102, a reflection of the beam or ray 420 to the at least one sensor 624, 626 with minimal scattering shows how the valve 102 absorbs the beam or ray 420. In one implementation, the beam or ray 420 of radiation from the radiation source 108 is a high-power beam such as a high-power laser beam. Inconsistent beam characteristics with a high level of absorption reflectance are indicative of a passing, weakened, or aging valve such as the value 102, or a weakness in the wellhead 104.

The sensor signals from the at least one sensor 624, 626 are transmitted through the wires 628, 630 to the ports 614, 616, respectively. The sensor signal receiver 610 generates a signature signal corresponding to the received sensor signals, which are transmitted via the communication channels 118 to the analysis system 114 as shown in FIG. 1.

In one implementation, the sensor structures 112, 512 in FIGS. 1-2 and 5, respectively, have a predetermined shape and dimensions configured to surround or fit onto the valves 102, 502, respectively. For example, the sensor structures 112, 512 have the shape of an unbroken and complete ring, an unbroken and complete annulus, a hemisphere, a portions of a spheres, a ring with a gap, or an annulus with a gap. In one implementation, the sensor structures 112, 512 have a standard width configured to fit around standard valves 102, 502, respectively. In one implementation, the sensor structures 112, 512 are composed of a rigid material, such as metallic material. In another implementation, the sensor structures 112, 512 are composed of a flexible material, such as fabric or plastic.

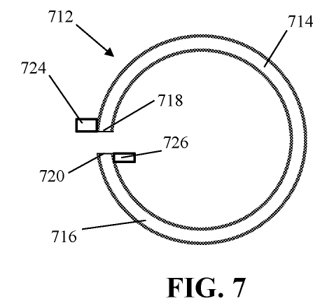

In alternative implementation of the sensor structure shown in FIG. 7, the sensor structure 712 has at least two portions 714, 716 with at least two ends 718, 720, respectively. In one implementation, the at least two portions 714, 716 of the sensor structure 712 are composed of a flexible material, such as fabric or plastic. During deployment of the sensor structure 712 to surround a valve for monitoring for leaks and anomalies, the at least two portions 714, 716 are positioned or wrapped about the valve.

In one implementation, the at least two portions 714, 716 are configured to be fastened together in any location along the lengths of the at least two portions 714, 716 to establish a cross-section or a diameter of the sensor structure 712 substantially matching the size and dimensions of the valve. The at least two portions 714, 716 are selectively fixed and secured in a selected shape and size surrounding the valve. In one implementation, at least one of the at least two portions 714, 716 includes a single fastener 724 to removably fasten the at least two portions 714, 716 together. For example, the single fastener 724 includes a screwable fastener for securing the portions 714, 716 together by friction or pressure. In another example, the single fastener 724 includes a buckle configured to engage holes in the at least two portions 714, 716. In a further implementation, the single fastener 724 is any known one-part fastener. Using the single fastener 724, the at least two portions 714, 716 are configured to be fastened together in any location along the lengths of the at least two portions 714, 716 to establish a cross-section or a diameter of the sensor structure 712 substantially matching the size and dimensions of the valve.

In an alternative implementation, the at least two portions 714, 716 includes a pair of complementary fasteners 724, 726 to removably fasten the portions 714, 716 together. For example, the pair of fasteners 724, 726 includes hook-and-loop fasteners, complementary clips, or other known two-part fasteners. In another implementation, the at least two portions 714, 716 are configured to be fastened together. In one implementation, at least one of the at least two portions 714, 716 includes a single fastener 724 to removably fasten the portions 714, 716 together. For example, the single fastener 724 includes a screwable fastener for securing the portions 714, 716 together by friction or pressure. In another example, the single fastener 724 includes a buckle configured to engage holes in the at least two portions 714, 716. In a further implementation, the single fastener 724 is any known one-part fastener. In an alternative implementation, at least one of the at least two portions 714, 716 includes a pair of complementary fasteners 724, 726 to removably fasten the portions 714, 716 together. For example, the pair of fasteners 724, 726 includes hook-and-loop fasteners, complementary clips, or other known two-part fasteners. Using the fasteners 724, 726, the at least two portions 714, 716 are configured to be fastened together in any location along the lengths of the at least two portions 714, 716 to establish a cross-section or a diameter of the sensor structure 712 substantially matching the size and dimensions of the valve.

In another implementation, the at least two ends 718, 720 are configured to be fastened together. In one implementation, at least one of the at least two ends 718, 720 includes a single fastener 724 to removably fasten the ends 718, 720 together. For example, the single fastener 724 includes a screwable fastener for securing the ends 718, 720 together by friction or pressure. In another example, the single fastener 724 includes a buckle configured to engage holes in the at least two portions 714, 716. In a further implementation, the single fastener 724 is any known one-part fastener. Using the single fastener 724, the at least two portions 714, 716 are configured to be fastened together in any location along the lengths of the at least two portions 714, 716 to establish a cross-section or a diameter of the sensor structure 712 substantially matching the size and dimensions of the valve.

In an alternative implementation, the at least two ends 718, 720 includes a pair of complementary fasteners 724, 726 to removably fasten the ends 718, 720 together. For example, the pair of fasteners 724, 726 includes hook-and-loop fasteners, complementary clips, or other known two-part fasteners. In another implementation, the at least two ends 718, 720 are configured to be fastened together. In one implementation, at least one of the at least two ends 718, 720 includes a single fastener 724 to removably fasten the ends 718, 720 together. For example, the single fastener 724 includes a screwable fastener for securing the ends 718, 720 together by friction or pressure. In another example, the single fastener 724 includes a buckle configured to engage holes in the at least two portions 714, 716. In a further implementation, the single fastener 724 is any known one-part fastener. In an alternative implementation, at least one of the at least two ends 718, 720 includes a pair of complementary fasteners 724, 726 to removably fasten the ends 718, 720 together. For example, the pair of fasteners 724, 726 includes hook-and-loop fasteners, complementary clips, or other known two-part fasteners. Using the fasteners 724, 726, the at least two portions 714, 716 are configured to be fastened together in any location along the lengths of the at least two portions 714, 716 to establish a cross-section or a diameter of the sensor structure 712 substantially matching the size and dimensions of the valve.

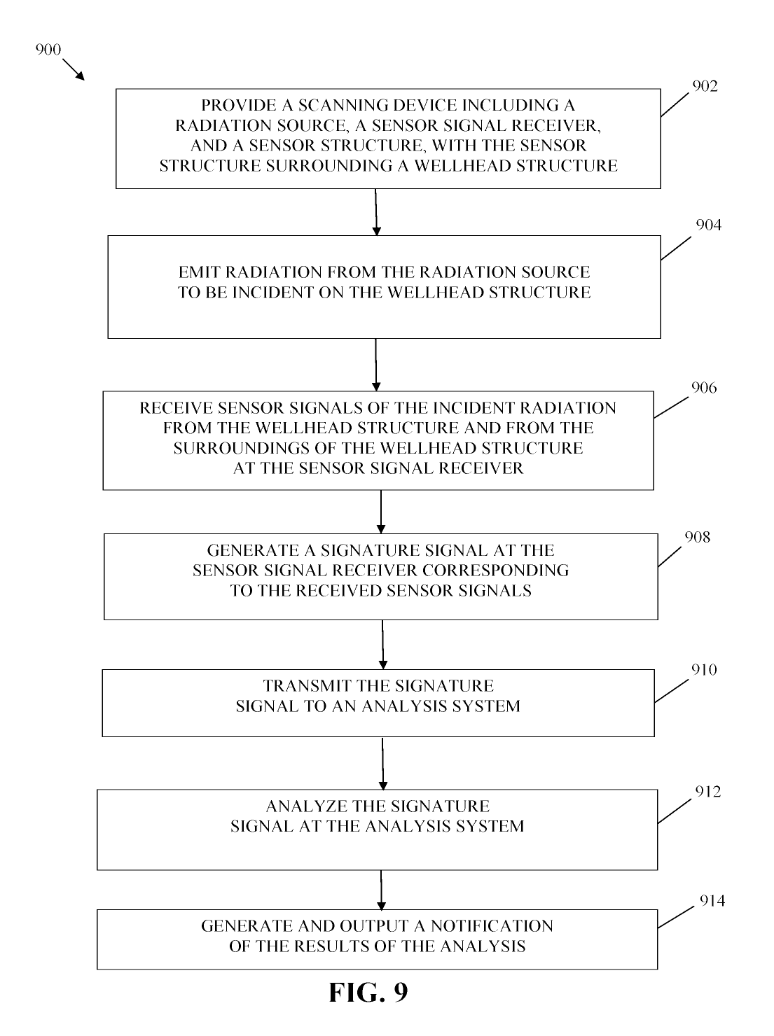

Referring to FIG. 9, a computer-based method 900 implements the assessment system 100 of FIG. 1 to operate the analysis system 114 in conjunction with the other equipment 108, 110, 112, 116, and 118. The method 900 includes providing a scanning device including a radiation source 108, a sensor signal receiver 110, and a sensor structure 112, with the sensor structure 112 surrounding a wellhead structure of a wellhead 104, such as a valve 102, as in step 902. The method 900 then emits radiation from the radiation source 108 to be incident on the wellhead structure and to also pass through the surroundings of the wellhead structure in step 904, receives sensor signals of the incident radiation from the wellhead structure at the sensor signal receiver in step 906, and generates a signature signal at the sensor signal receiver corresponding to the received sensor signals in step 908. The method 900 then transmits the signature signal to an analysis system 114 in step 910, analyzes the signature signal at the analysis system 114 in step 912, and generates and outputs a notification of the results of the analysis in step 914, for example, using the user interface 808, such as the input/output device 810.

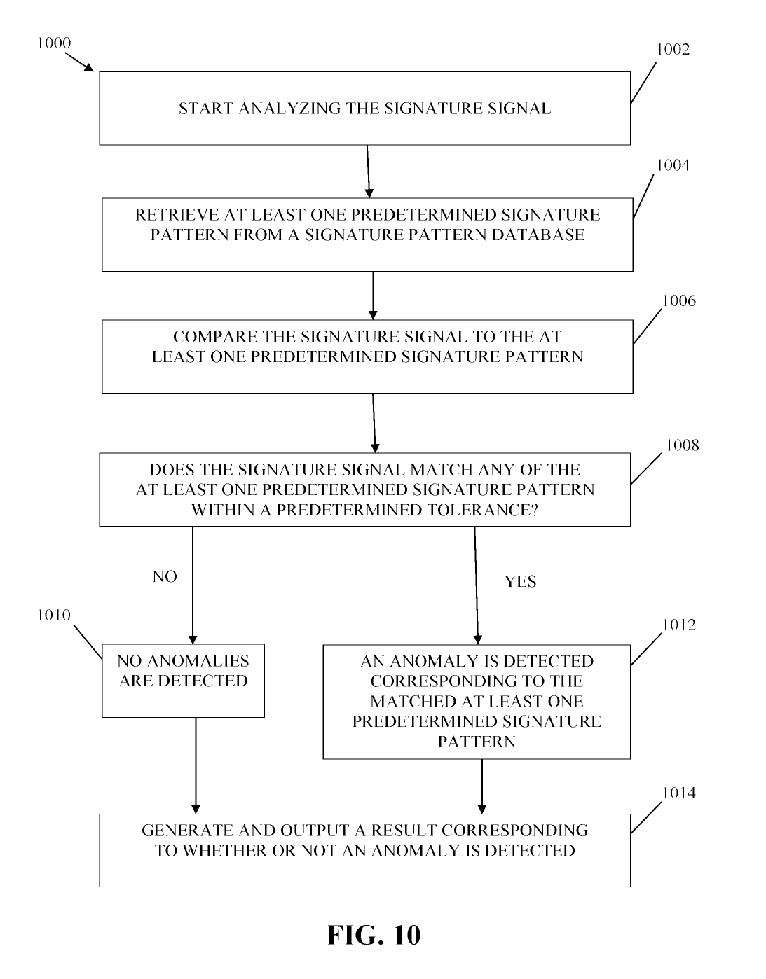

Referring to FIGS. 9-10, the step 912 of analyzing includes the method 1000 of FIG. 10, which includes starting the analyzing the signature signal in step 1002, retrieving at least one predetermined signature pattern from a signature pattern database stored in the memory 804 in step 1004, and comparing the signature signal to the at least one predetermined signature pattern in step 1006. The at least one predetermined signature pattern represents signals corresponding to known leaks, anomalies, or other irregularities associated with the valve 102. The analysis system 114 determines whether the signature signal matches any of the at least one predetermined signature pattern in the signature pattern database to within a predetermined tolerance in step 1008. In one implementation, the predetermined tolerance is 1 %, indicating that about 99 % of the signature signal matches at least one predetermined signature pattern. In another implementation, the analysis system 114 performs a correlation of the signature signal and each of the at least one predetermined signature pattern, and a correlation of greater than 99 % indicates that the signature signal matches at least one predetermined signature pattern.

If no match of the signature signal matches at least one predetermined signature pattern in step 1008, then the analysis system 114 determines that no anomalies are present in the operation of the valve 102 in step 1010. However, if a match of the signature signal with at least one predetermined signature pattern is determined in step 1008, then the analysis system 114 determines that an anomaly is detected in the operation of the valve 102 in step 1012, with the anomaly corresponding to the matched at least one predetermined signature. The analysis system 114 then generates and outputs a notification of the presence or absence of an anomaly in the operation of the valve 102 in step 1014. In one implementation, the notification is output by the user interface 808, such as a displayed message to a user on a display implementing the input/output device 810. In another implementation, the notification is output by the user interface 808 as a physical printout provided to a user from a printer implementing the input/output device 810. In another implementation, the analysis system 114 generates and outputs a report including the notification transmitted through the communication interface 806 to external systems monitoring the wellhead 104 and the valves 102 of the wellhead.

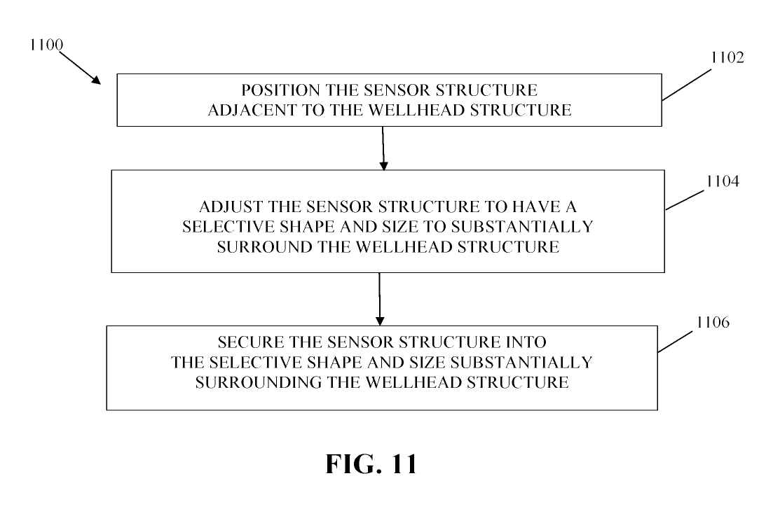

As shown in FIG. 11, a method 1100 of adjusting the sensor structure of FIG. 7 includes the steps of position the sensor structure 712 adjacent to the wellhead structure in step 1102, adjusting the sensor structure 712 to have a selective shape and size to substantially surround the wellhead structure 1104, and securing the sensor structure 712 into the selective shape and size substantially surrounding the wellhead structure in step 1106, as described above.

Portions of the methods described herein can be performed by software or firmware in machine readable form on a tangible or non-transitory storage medium. For example, the software or firmware can be in the form of a computer program including computer program code adapted to cause the system to perform various actions described herein when the program is run on a computer or suitable hardware device, and where the computer program can be implemented on a computer readable medium. Examples of tangible storage media include computer storage devices having computer-readable media such as disks, thumb drives, flash memory, and the like, and do not include propagated signals. Propagated signals can be present in a tangible storage media. The software can be suitable for execution on a parallel processor or a serial processor such that various actions described herein can be carried out in any suitable order, or simultaneously.

It is to be further understood that like or similar numerals in the drawings represent like or similar elements through the several figures, and that not all components or steps described and illustrated with reference to the figures are required for all embodiments, implementations, or arrangements.

The terminology used herein is for the purpose of describing particular implementations only and is not intended to be limiting of the invention. As used herein, the singular forms "a," "an," and "the" are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of "including," "comprising," "having," "containing," "involving," and variations thereof herein, is meant to encompass the items listed thereafter and equivalents thereof as well as additional items.

While the disclosure has described several exemplary implementations, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to implementations of the disclosure without departing from the essential scope thereof. Therefore, it is intended that the invention not be limited to the particular implementations disclosed, or to the best mode contemplated for carrying out this invention, but that the invention will include all implementations falling within the scope of the appended claims.

The subject matter described above is provided by way of illustration only and should not be construed as limiting. Various modifications and changes can be made to the subject matter described herein without following the example embodiments, implementations, and applications illustrated and described, and without departing from the true spirit and scope of the invention encompassed by the present disclosure, which is defined by the set of recitations in the following claims and by structures and functions or steps which are equivalent to these recitations.

What is claimed is:

1. An assessment system configured to assess a given structure, comprising:
a radiation source configured to emit a predetermined electromagnetic radiation towards the given structure;
a sensor structure configured to detected electromagnetic radiation corresponding to changes in the predetermined electromagnetic radiation due to the given structure;
a sensor signal receiver configured to receive a detection signal corresponding to the detected electromagnetic radiation, to generate a signature signal corresponding to the detected electromagnetic radiation, and to transmit the signature signal;
an analysis system including:
a memory configured to store a database of predetermined patterns each
corresponding to a respective anomaly in the given structure;
a hardware-based processor, responsive to receiving the signature signal, to compare the signature signal to the predetermined patterns, to determine any match of the signature signal to a first predetermined pattern, and to generate a notification of an anomaly of the given structure in the case of a match of the signature signal to at least one of the predetermined patterns; and
an output device configured to output the notification to a user.

2. The assessment system of claim 1, wherein the radiation source is a laser configured to emit a laser beam as the predetermined electromagnetic radiation towards the given structure.

3. The assessment system of claim 1, wherein the sensor structure further comprises:
a curved structure surrounding at least a portion of the given structure.

4. The assessment system of claim 3, wherein the sensor structure further comprises:
a reflective surface configured to detect the predetermined electromagnetic radiation incident in the surroundings of the given structure, and to reflect the detected electromagnetic radiation as the detection signal to the sensor signal receiver.

5. The assessment system of claim 3, wherein the sensor structure further comprises:
at least one sensor embedded in the curved structure to detect the predetermined electromagnetic radiation incident in the surroundings of the given structure, and to generate the detection signal corresponding to the detected electronic radiation; and
at least one electrical wire configured to transmit the detection signal to the sensor signal receiver.

6. The assessment system of claim 3, wherein the curved structure has a shape configured to surround at least a portion of the given structure,
wherein the shape is selected from the group consisting of a complete ring, a complete annulus, a hemispheres, a portion of a sphere, a ring with a gap, or an annulus with a gap.

7. The assessment system of claim 6, wherein the sensor structure further comprises:
at least one fastener configured to selectively fix and secure the curved structure in a selected shape and size surrounding the given structure.

8. The assessment system of claim 1, further comprising:
a communication channel configured to transmit the signature signal from the sensor signal receiver to the analysis system.

9. The assessment system of claim 8, wherein the communication channel is a wired connection.

10. The assessment system of claim 8, wherein the communication channel is a wireless connection.

11. A method to assess a given structure, comprising:
emitting a predetermined electromagnetic radiation from a radiation source towards the given structure;
detecting, by a sensor structure, electromagnetic radiation corresponding to changes in the predetermined electromagnetic radiation due to the given structure;
receiving a detection signal corresponding to the detected electromagnetic radiation;
generating a signature signal corresponding to the detected electromagnetic radiation;
transmitting the signature signal to an analysis system;
receiving the signature signal at the analysis system;
retrieving at least one predetermined pattern from a database, wherein the at least one predetermined pattern corresponds to an anomaly of the given structure;
comparing the signature signal to the at least one predetermined pattern;
determining any match of the signature signal to a first predetermined pattern;
responsive to a match of the signature signal to a first predetermined pattern, generating and outputting a notification of an anomaly of the given structure corresponding to the anomaly corresponding to the first predetermined pattern; and
outputting, through a user interface, the notification of the anomaly of the given structure to a user.

12. The method of claim 11, wherein the radiation source is a laser emitting a laser beam as the predetermined radiation towards the given structure.

13. The method of claim 11, further comprising:
prior to emitting the predetermined electromagnetic radiation, surrounding at least a portion of the given structure with a portion of a curved structure of the sensor structure.

14. The method of claim 13, wherein the portion of the curved structure has a shape configured to surround at least the portion of the given structure,
wherein the shape is selected from the group consisting of a complete ring, a complete annulus, a hemispheres, a portion of a sphere, a ring with a gap, or an annulus with a gap.

15. The method of claim 13, further comprising:
prior to detecting the electromagnetic radiation, providing a reflective surface on the curved structure,
wherein detecting the predetermined electromagnetic radiation incident in the surroundings of the given structure includes reflecting the detected electromagnetic radiation as a detection signal to a sensor signal receiver.
